(19) United States
(12) Patent Application Publication
(10) Pub. No.: US 2024/0428156 A1
(43) Pub. Date: Dec. 26, 2024

(54) METHOD AND SYSTEM FOR RECOMMENDING A WORKPLAN SCHEDULE

(71) Applicant: Microsoft Technology Licensing, LLC, Redmond, WA (US)

(72) Inventors: Chin-Chia HSU, Redmond, WA (US); Longqi YANG, Issaquah, WA (US); Siddharth SURI, Redmond, WA (US)

(73) Assignee: Microsoft Technology Licensing, LLC, Redmond, WA (US)

(21) Appl. No.: 18/339,179

(22) Filed: Jun. 21, 2023

(51) Int. Cl. G06Q 10/0631; G06Q 10/0639

(52) U.S. Cl. CPC G06Q 10/063118; G06Q 10/06393

(57) ABSTRACT

A system and method for automatically generating a workplan schedule for a team of employees in an organization includes receiving a request to create a workplan schedule for the team, the team including two or more team members who are employees of the organization and the workplan schedule identifying a work location for the team members. One or more collaborators for one or more of the team members is detected, where the collaborator is an employee of the organization who is not a member of the team and with whom at least one of the team members collaborate. A preference alignment parameter for the team members is then measured for the one or more workdays and a utility parameter for one or more of the team members is measured where the utility parameter is based on the preference alignment parameter, a team member co-location parameter for the one or more of the two or more team members being at a same location as their team members, and a co-location with collaborators parameter for the one or more of the two or more team members being at a same location as the one or more their collaborators. The utility parameters for the team members are then aggregated and a maximization function is applied to the aggregated utility parameter based on a relative weighing of the preference alignment parameter, the team member co-location parameter and the co-location with collaborators parameter to generate the workplan schedule based on the maximized aggregated utility parameter.

### BACKGROUND

In today's flexible and collaborative work and social environments, many users work remotely or from different geographical locations, while others work from the office. Many workers spend a few days a week working at the office and a few days working from home. This results in a hybrid work structure that is increasingly becoming popular as it offers flexibility and autonomy to workers while providing benefits of in-person interactions. As a result, many managers are looking for ways to generate a workplan that while providing flexibility to the employees in their team, also offers opportunities for the team members to meet and collaborate in person. This requires balancing many interests, preferences and schedules, as the members of any given team may have different needs, schedules and preferences. To make the process more complex, each of the team members may have specific individuals with which they collaborate for their work. The collaborators may not be the same for the team members. Currently workplan scheduling systems cannot take these various parameters into account.

Hence, there is a need for improved systems and methods of generating a hybrid workplan schedule.

### SUMMARY

In one general aspect, the instant disclosure presents a data processing system having a processor and a memory in communication with the processor wherein the memory stores executable instructions that, when executed by the processor, cause the data processing system to perform multiple functions. The function may include retrieving employee data associated with a plurality of employees of an organization; retrieving team data for a team of employees of the organization, the team including two or more team members; retrieving collaboration data associated with collaboration between the plurality of employees; identifying, using a collaboration detection engine, based on the collaboration data, one or more collaborators for one or more team members, the one or more collaborators being employees of the organization who are not a team member of the team; measuring for each team member for each of one or more days of a week, using a preference detection engine, a value for a likelihood that the team member prefers to work from a specific location on each of the one or more days of the week; measuring a preference alignment parameter for the two or more team members based on the measured value for the likelihood that the team member prefers to work from the specific location on each of the one or more days of the week; measuring a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more their collaborators; aggregating the utility parameter for the two or more team members; applying a maximization function to the aggregated utility parameter based on a relative weighing of the preference alignment parameter, the team member co-location parameter and the co-location with collaborators parameter; and generating a workplan schedule for the team based on the maximized aggregated utility parameter.

In yet another general aspect, the instant disclosure presents a method for automatically generating a workplan schedule for a team of employees in an organization. In some implementations, the method includes receiving, via a user interface screen of an application, a request to automatically create a workplan schedule for the team, the team including two or more team members who are employees of the organization and the workplan schedule identifying for one or more workdays a work location for the two or more team members; detecting, using a collaboration detection engine, a collaborator for one or more of the two or team members, the collaborator being an employee of the organization who is not a member of the team and with whom at least one of the two or more team members collaborate; measuring, using a workplan generating engine, a preference alignment parameter for the two or more team members for the one or more workdays; measuring, using the workplan generating engine, a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more of their collaborators; aggregating the utility parameter for the two or more team members; applying a maximization function to the aggregated utility parameter based on a relative weighing of the preference alignment parameter, the team member co-location parameter and the co-location with collaborators parameter; and generating the workplan schedule based on the maximized aggregated utility parameter.

In a further general aspect, the instant application describes a non-transitory computer readable medium on which are stored instructions that when executed cause a programmable device to perform functions of identifying, using a collaboration detection engine, one or more collaborators for one or more team members of a team, the collaboration detection engine identifying the one or more collaborators based on collaboration data associated with collaboration between a plurality of employees of an organization, the one or more collaborators being employees of the organization who are not a team member of the team; measuring for each team member for each of one or more days of a week, using a preference detection engine, a value for a likelihood that the team member prefers to work from a specific location on each of the one or more days of the week; measuring a preference alignment parameter for the one or more team members based on the measured value for the likelihood that the team member prefers to work from the specific location on each of the one or more days of the week; measuring a utility parameter for one or more of the one or more team members, the utility parameter being measured based on the preference alignment parameter, a team member co-location parameter for the one or more of the one or more team members being at a same location as their team members, and a co-location with collaborators parameter for the one or more of the one or more team members being at a same location as the one or more of their collaborators; aggregating the utility parameter for the one or more team members; applying a maximization function to the aggregated utility parameter based on a relative weighing of the preference alignment parameter, the team member co-location parameter and the co-location with collaborators parameter; and generating a workplan schedule for the team based on the maximized aggregated utility parameter.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts some elements involved in providing hybrid workplan scheduling services.

FIGS. 3A-3D depict example data structures that are generated during a process of creating an optimized hybrid workplan schedule.

FIGS. 4A-4D depict example graphical user interface (GUI) screens of an application or service that automatically generates an optimized hybrid workplan schedule for a team.

FIG. 5 is a flow diagram depicting an example method for recommending a hybrid workplan schedule for a team.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

With the flexibility provided to employees to work remotely, many individuals are choosing a work location convenient to them based on their needs and/or personal preferences. For example, an individual may work from a coffee shop, their house, a hotel or any other place of their choosing one or more workdays, while choosing to work from the office the other days of the week. This results in a hybrid work schedule that while being popular with employees is difficult to manage for managers. That is because many managers need to optimize the workplan schedule such that the employees can benefit from flexibility but also maintain the advantages of face-to-face interactions and collaborations. However, designing effective and efficient hybrid workplans is a challenging and complex task that requires balancing multiple objectives and constraints. Moreover, current workplan scheduling systems are not designed for hybrid workplans and cannot take into account all of the factors involved in optimizing a hybrid workplan. Thus, currently available mechanisms for organizing a workplan are too simplistic to take into account all the factors involved in optimizing a hybrid workplan and thus are not able to provide recommendations for optimizing a hybrid workplan for a team. As such, there exists a technical problem of lack of adequate mechanisms for providing recommendations for an optimized hybrid workplan schedule for a team.

To address these technical problems and more, in an example, this description provides technical solutions for providing a recommendation system that automatically provides an optimized workplan schedule for a team. The system utilizes organizational and user data, such as corporate organizational hierarchy and relationships, team data, employee location data, individual employee's work preferences, and/or collaboration data obtained via organizational graph data, telemetry data and/or user input data. An optimized workplan schedule is then generated based on a utility function that includes a preference alignment component, a co-location team member component and a co-location collaboration component. The system then applies a maximization function that maximizes the team's aggregate utility based on an external input of relative weighing of the three components. After optimization, the system outputs a recommendation for an optimized workplan for the team. Thus, the technical solution takes into account individual preferences on working from home or office, co-location, and collaboration in offices, as well as the structure and dynamics of collaboration networks among employees. By applying advanced optimization algorithms and network metrics, the system maximizes connectivity among employees in a hybrid mode while respecting individual needs. As a result, the technical solution provides a systematic and quantitative solution to the challenges of hybrid work scheduling, enabling employees and managers to make informed decisions on their workplans and improve productivity in a hybrid work environment.

The technical solution described herein addresses the technical problem of lack of mechanisms for generating a hybrid workplan schedule for a team in an organization having a plurality of teams, where the hybrid workplan schedule optimizes collaboration and takes employee preferences into account. The technical solution allows a manager or team leader to provide a list of employees in their team and/or simply request the system to generate an optimized hybrid workplan schedule for their team. The technical solution utilizes artificial intelligence (AI) and use of trained machine-learning (ML) models to detect teams, detect user preferences and identify collaborators with which members of a team regularly collaborate to quickly and efficiently access data relevant to optimization of a hybrid workplan schedule and to automatically generate an optimized hybrid workplan based on various identified or detected parameters. The technical effects at least include (1) improving the efficiency of using an electronic device to generate an optimized hybrid workplan schedule; (2) optimizing use of employee's resources and time by identifying dates on which their presence in the office is likely to be beneficial; and (3) providing user interface (UI) elements that increase user efficiency and user satisfaction by enabling the user to review recommendations for an optimized hybrid workplan schedule.

As will be understood by persons of skill in the art upon reading this disclosure, benefits and advantages provided by such implementations can include, but are not limited to, a technical solution to the technical problems of lack of adequate mechanisms for accurately and automatically creating a hybrid workplan schedule that optimizes various parameters. The benefits made available by these technology-based solutions provide automated, optimized and efficient mechanisms for facilitating collaboration between employees while also offering flexibility to the employees.

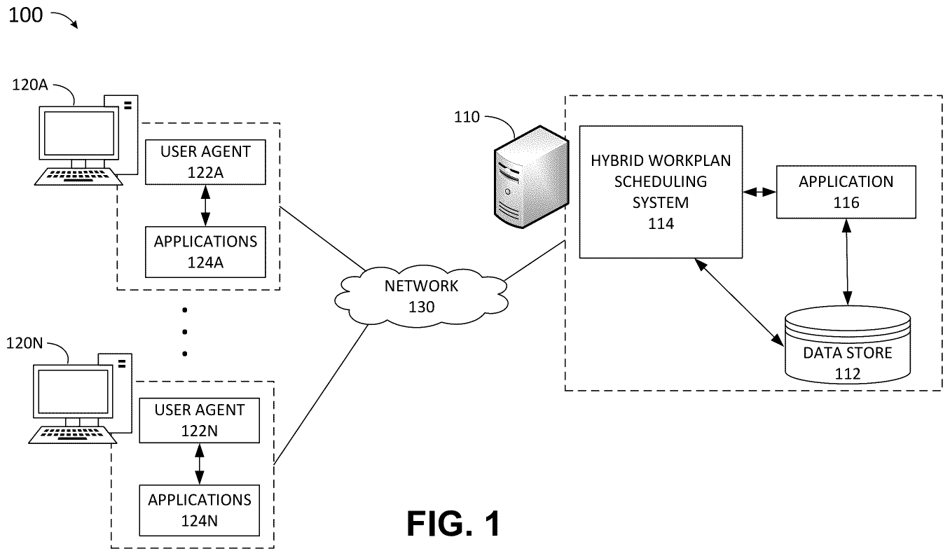

FIG. 1 illustrates an example system 100, upon which aspects of this disclosure may be implemented. The system 100 includes a server 110 which is connected to or includes a data store 112 which functions as a repository in which data sets relating to user preferences, user data, organizational data, communications data, facility data, and the like may be stored. Although shown as a single data store, the data store 112 may be representative of multiple storage devices and data stores which may be connected to each of the various elements of the system 100. Furthermore, although the data store 112 is shown as being part of the server 110, one or more elements (e.g., storage mediums) of the data store 112 may be provided in separate storage servers or other types of servers. Moreover, the server 110 may include a plurality of servers that work together to deliver the functions and services provided by each service or application. The server 110 may operate as a cloud-based server for offering hybrid workplan recommendation services in one or more applications such as application 116 and/or applications 124. Server 110 may operate as a shared resource server located at an enterprise accessible by various computer client devices such as client devices 120A-120N (referred to collectively as client device 120).

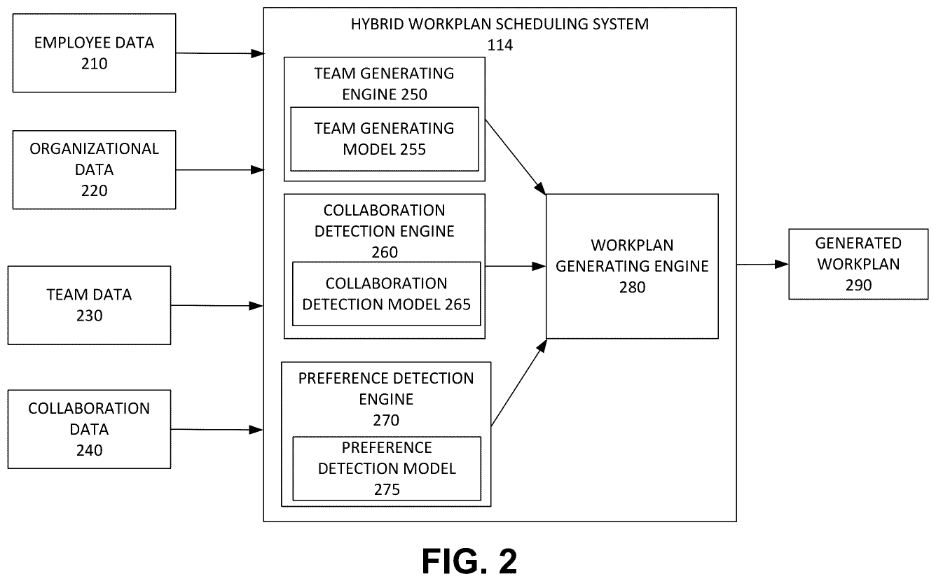

The server 110 includes and/or executes a hybrid workplan scheduling system 114 which provides hybrid workplan scheduling services for users utilizing an application that provides hybrid workplan scheduling recommendations on their client devices such as client device 120A-120N. The hybrid workplan scheduling system may operate to receive and/or detect one or more teams in an organization, receive and/or identify user work mode preferences, and receive and/or identify collaborators with which team members collaborate on a regular basis. Based on the detected and/or parameters, the hybrid workplan scheduling system 114 generates a workplan schedule that for each day of a work week, identifies which team members should work from home and which ones should go to the office. The hybrid workplan scheduling system 114 transmits the generated workplan schedule to an application for display to a user such as a team leader or manager for use. The hybrid workplan scheduling system 114 may include one or more separate elements that perform each of the functions of team generation, collaboration detection, and/or user preference detection, as further discussed below with respect to FIG. 2.

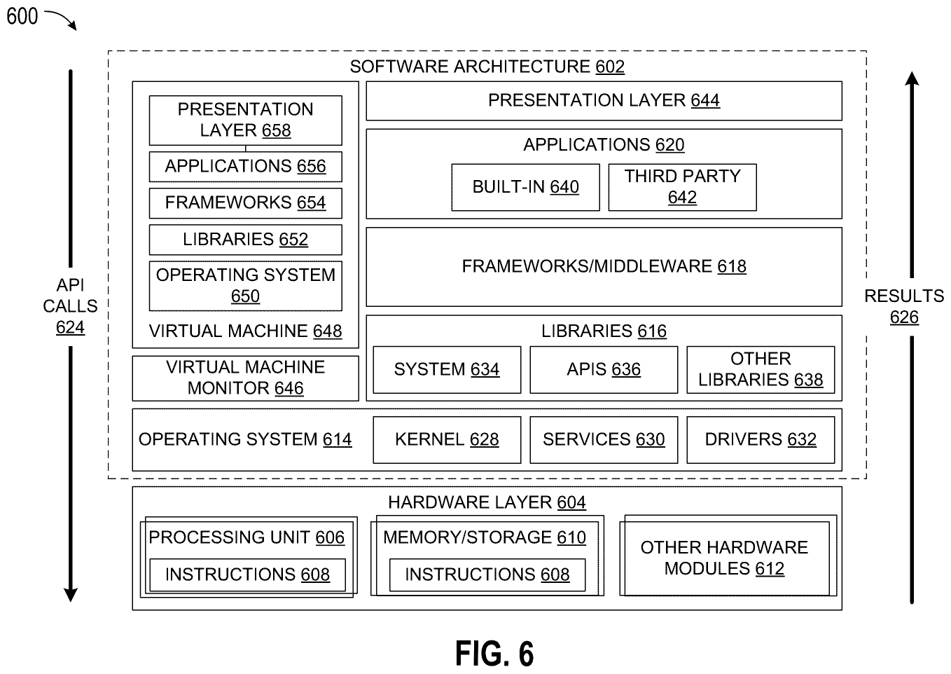

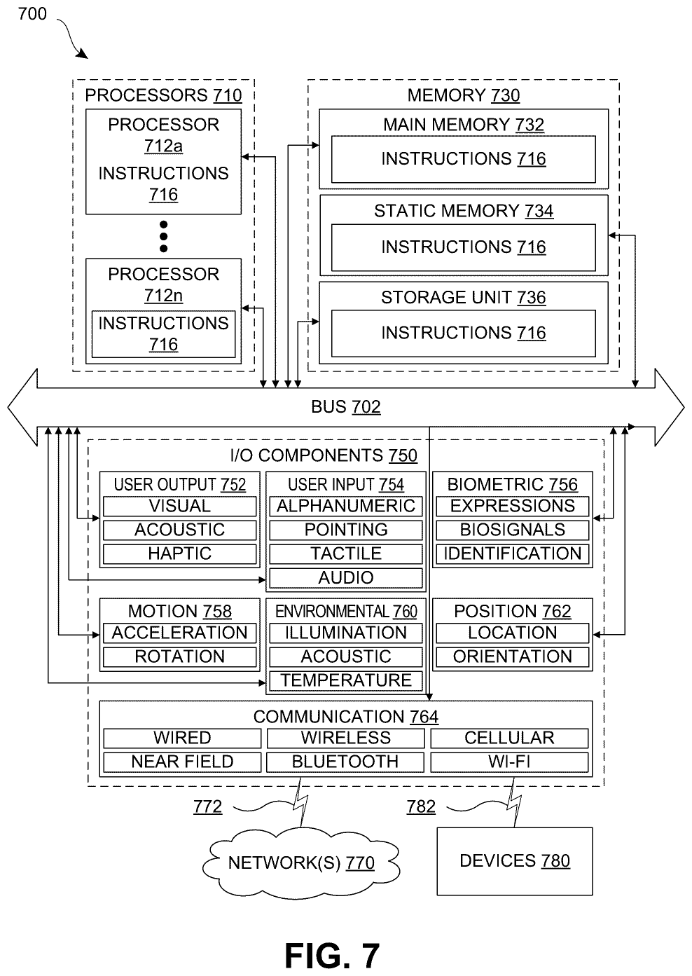

Each of the client devices 120A-120N may be connected to the server 110 via a network 130. The network 130 may be a wired or wireless network(s) or a combination of wired and wireless networks that connect one or more elements of the system 100. The client devices 120A-120N may be personal or handheld computing device having or being connected to input/output elements that enable a user to interact with various applications (e.g., application 116 or applications 124A-124N). Examples of suitable client devices 120A-120N include but are not limited to personal computers, desktop computers, laptop computers, mobile telephones, smart phones, tablets, phablets, smart watches, wearable computers, gaming devices/computers, televisions, and the like. The internal hardware structure of a client device is discussed in greater detail in regard to FIGS. 6 and 7.

Each of the client devices 120A-120N may be associated with a different user. In some implementations, a client device 120 is associated with a team leader or manager who utilizes an application such as online application 116 or local applications 124 to submit a request for receiving a workplan schedule recommendation. A user such as an employee may also use a client device 120 to provide their preferences such as their preferred work location for a given day. Each application 124A-124N may be a computer program executed on the client device that configures the device to be responsive to user input to allow a user to use workplan scheduling tools such as providing team information, providing employee preference information and/or requesting recommendations for a workplan schedule. The application 124A-124N also represent applications used by users for collaboration. Data from these collaborations may be collected and used to identify collaborators of a given user. The applications 124A-124N are native applications that provide workplan scheduling services. Examples of suitable applications include, but are not limited to, work environment applications (e.g., Microsoft Places), collaborative work environment applications, communications application (e.g., Microsoft Teams or Microsoft Outlook), and the like.

In some examples, applications used for providing workplan scheduling services are executed on the server 110 (e.g., application 116) and are provided via an online service. In some implementations, web applications communicate via the network 130 with a user agent 122A-122N, such as a browser, executing on the client device 120A-120N. The user agent 122A-122N may provide a UI that allows the user to interact with application 116 and may enable application 116 to provide data to the hybrid workplan scheduling system 114 for processing. In some implementations, the hybrid workplan scheduling system 114 is included in the application 116. In some implementations, the workplan scheduling services of the hybrid workplan scheduling system 114 are provided via a website accessible by the user agents 122A-122N.

FIG. 2 depicts some elements involved in providing hybrid workplan scheduling services. In some implementations, the hybrid workplan scheduling system 114 receives employee data 210, organizational data 220, team data 230 and/or collaboration data 240. The data may be received from a data storage medium that stores data such as the data store 112. The data may be retrieved as needed.

Employee data 210 may include a user identification for one or more employees. In some implementations, employee data 210 only includes data for employees of a team for which a workplan schedule is being generated. In an example, employee data 210 includes user preference data such as a user's preference to work from home or office. This may include specific preferences for one or more days of the work week. For example, an employee may specify that they prefer to work Mondays and Fridays from home, while preferring to work Tuesdays through Thursdays from the Office. This information may be provided directly by the employee or the employee's manager via a user interface element, stored in a data structure and/or retrieved by the hybrid workplan scheduling system 114, when it is generating a workplan for a team that includes the user. Alternatively, the user preference data is inferred from other data. In situations where user preference data is inferred, employee data 210 includes location and/or user history data such as location history data (e.g., the location at which the user works from each day of the week).

Location data may be collected or inferred from a user's Internet Protocol (IP) address, GPS data, data relating to pinging a user's mobile device, network connection data (e.g., connection to a Wi-Fi in a building), health check data (e.g., when the user completes their health check at a specific building), and external data sources such as toll road data or public transportation data (e.g., train or bus tickets purchased). Location data may also be inferred from voice analysis conducted during a virtual meeting. For example, voice analysis may be performed to determine whether a user is in a conference room with other users or the user is attending the meeting remotely. Furthermore, location information may be inferred from organizational security data such as when the user uses a badge to enter a facility.

In addition to location information, employee data 210 may include calendar data and communications data such as data relating to messages (e.g., email, instant messages, text messages), data relating to calls, video calls and the like for a given employee. The calendar and communications data may provide information about the user's possible location. For example, calendar data may indicate that the user has a meeting at a specific location thus indicating the user's work location for that day. This information may also be retrieved and/or inferred from communications data (e.g., from emails, instant messages, and the like). It should be noted that in collecting and retrieving a user's geographical data, communication data or other private data, care is taken to ensure all privacy guidelines and regulations are followed. For example, receiving a user's consent for collection, retrieval, storage and use of their data may be required.

Organizational data 220 includes employment data for employees of the organization. This includes a user identification parameter for the employees, the city, state and/or country in which they reside, the organization's office from which they are based on, and/or their manager (e.g., the person to which they report). The organizational data 220 may also include weighting factors that indicates the importance of each of employee preference, co-location of team members and co-location of collaborators in the generated workplan schedule. The organizational data 220 can be retrieved from an organization's graph data or any other data structure in which employment data and/or management hierarchy data is stored.

In some implementations, organizational data 220 also includes facility data which is data collected from smart building features such as light sensors, building temperatures (e.g., when a room's temperature is changed by a user, that indicates that a user is in the room), use of a smart speaker in a room, use of a TV or other audio/video equipment, and/or use of appliances (e.g., coffee machine). Moreover, facility data may be collected from reservation systems. For example, organizations that enable their employees to reserve a space (e.g., workspace or conference room), may collect the reservation information, along with data about the person who made the reservation and/or a list of persons that will be at the reserved space. This information can be used to determine a user's location in the past. In some implementations, this information is provided via an application programming interface (API).

In some implementations, the hybrid workplan scheduling system 114 also receives team data 230. Team data 230 may include data that divides the employees into different teams. The teams may be predetermined, for example, based on the organization's structure. For example, an organization may have a sales team, a marketing team, a finance team, and engineering team and the like, and each employee may be designated as being a part of a specific team. Data about the organization's teams includes a team identification (e.g., a number or name given to the team) and the employees that are designated as belonging to that team. In some implementations, team data 230 is provided by a requesting user. For example, the user who utilizes a UI screen to submit a request for receiving an automatically generated hybrid workplan schedule, may provide a list of employees (e.g., employee names or IDs) that the requesting user wants to include in their workplan schedule. The team the requesting user identifies may correspond to one of the organization's teams or it may be a completely different team. In some implementations, team data 230 simply contains organizational graph data which includes the manager to which each employee reports. This information is then used to generate one or more teams for the organization.

Collaboration data 240 includes data related to an employee's collaborations with other employees. In some implementations, collaborators are identified by the requesting user or selected by a team member. For example, the requesting user may provide the name or user ID of one or more people with which a given team member is known to collaborate. In another example, team members are provided with an option to identify their collaborators (e.g., via a survey or a user interface element of an application or webpage. A collaborator is referred to herein as a person with whom another person often interacts, works with, communicates with, or sees in-person who is not a team member. As such, collaborators are individuals outside of the team with whom one or more team members collaborate. When a team member's collaborators are not known, the collaboration data 240 includes communications data (e.g., emails, instant messages, text message, comments on documents and the like), meeting data (e.g., participants in meetings in which the employee is a presenter and/or a participant), document data (e.g., users with which the employee often works on the same document), and the like. This enables the hybrid workplan scheduling system 114 to detect collaborators for team members. In an example, collaboration data 240 also includes data relating to the employee's coworkers with whom the user frequently works on the same projects or people that the user frequently meets in person. The collaboration data 240 may be retrieved from telemetry data stored for various employees of an organization. In some implementations, there are some overlaps between the employee data and the collaboration data 240.

In situations where the team for which a hybrid workplan schedule is being generated is not defined, the received and/or retrieved employee data, organizational data 220 and/or team data 230 is provided to the team generating engine 250 to generate one or more teams for which a hybrid workplan schedule should be generated. This may occur when the requesting user does not provide information about the team for which the workplan should be generated. It may also occur when a user requests that an optimized hybrid workplan scheduled be created for the entire organization or a portion of the organization, which should be divided into multiple teams. For example, a user may request that a hybrid workplan schedule be generated for all employees based in a specific city (e.g., all employees based in Boston). The hybrid workplan scheduling system 114 can then utilize the employee data 210 and/or organizational data 220 to identify the employees that work in the specific city and use the organizational data 220 and/or collaboration data 240 to generate a plurality of teams for the employees in the specific city. A similar process may be used to generate one team for a requesting user.

In some implementations, teams are generated based on the manager to which each employee directly reports. In such implementations, the manager and all of the employees to whom the manager reports are designated as belonging to the same team. For example, if a manager has 12 employees who directly report to him, the manager and the 12 employees are identified as belonging to one team. In an example, the hybrid workplan scheduling system 114 determines that the requesting user is a manager and identifies all the employees that report to the requesting user as belonging to the same team as the manager.

In alternative implementations, teams are generated based on a variety of parameters such as field of work (e.g., sales, finance, engineering, etc.), employee title, project (e.g., employees that work on same or similar projects), city or residence (e.g., employees that live in Boston and work in finance), degree of collaboration, relationship (e.g., same level in the organization's hierarchical structure or being a manager/directed report, etc.). In an example, when a team is generated by examining various parameters, a team generating model 255 is used. The team generating model 255 may be a trained model that analyzes various organizational, employee and collaboration data points and determines based on the examined parameters which members belong to the same team. The output of the team generating model 255 is a list of employees belonging to a team.

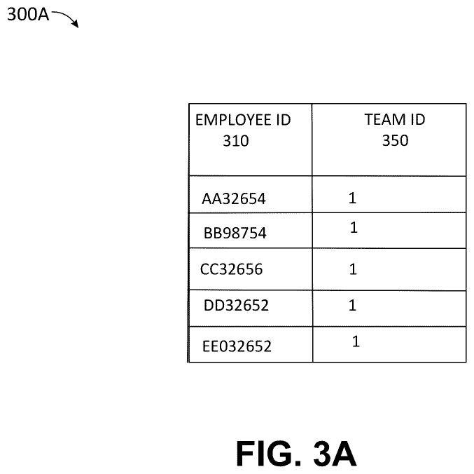

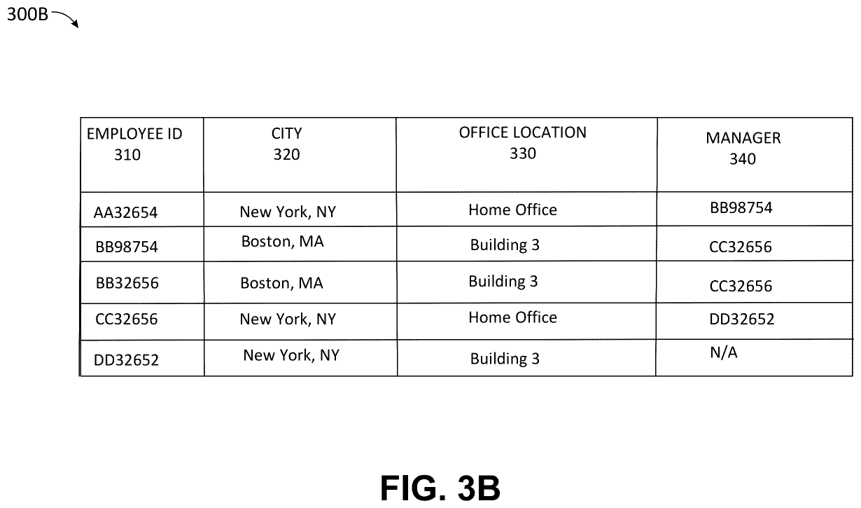

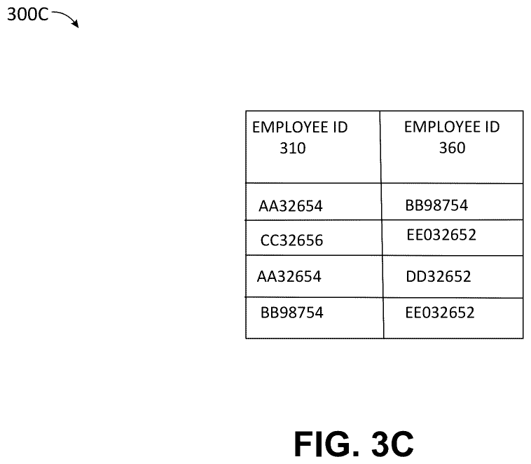

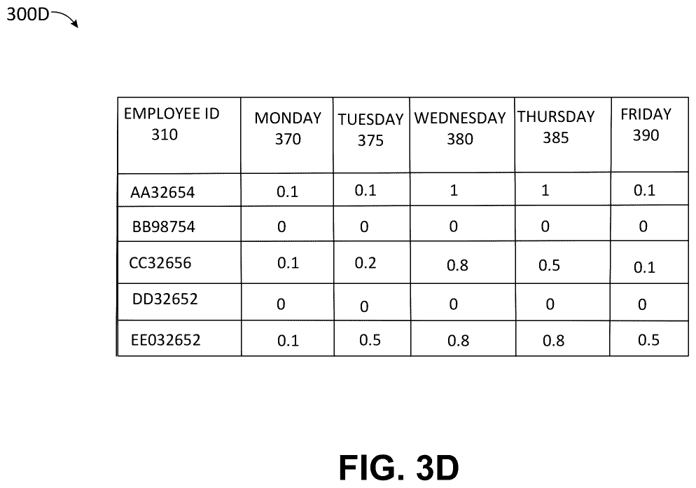

Once teams are identified, the team generating engine 250 utilizes a data structure to store the team's data. FIG. 3A depicts an example data structure 300A for storing team data for a given team. As depicted, the data includes an employee ID field 310 which stores employee IDs for the employees in the identified team. Additionally, data structure 300A includes a team ID field 350 for storing a team ID for the team. In this manner, the employees whose preferences and collaboration data needs to be examined and/or determined to generate a hybrid workplan schedule for the team can be easily identified. FIG. 3B depicts an example data structure 300B representing additional data about employees in a given team. As depicted, the data includes an employee ID field 310 which stores employee IDs for the employees, a city field 320 which stores the city in which each employee lives, an office location field 330, which stores the office location from which the employee has been identified as working from and the employee's direct manager. The office location from which a user works may be provided by the user or may be retrieved from organizational data 220. For example, the HR data stored for the user may include data about the status under which the user was hired or the last official mode of work recorded for the user. The manager field 340 may be obtained from a top to bottom organizational hierarchy chart that lists the CEO at the top and lists each person to which the CEO reports directly at a lower level, and so on, such that each employee except for the CEO has one person to which they directly report. As depicted in FIG. 3B, a team can include multiple managers.

In addition to generating teams, the hybrid workplan scheduling system 114 may also detect collaboration between one or more members of a team and other employees of the organization. This involves examining the collaboration data 240 to detect collaborators for one or more team members. In some implementations, this involves use of a collaboration detection model 265. The collaboration detection model 265 is a trained ML model that is trained to receive collaboration data associated with an employee (e.g., the employee's communication data, calendar data, documents, social media interactions and the like) and determine based on the received data which employees in the organization the employee most often collaborates with. In an example, the collaboration detection model 265 provides a few top ranked identified collaborators as an output (e.g., top 2). Once the collaborators are detected or after collaborators are provided as an input by the requesting user or team member, the hybrid workplan scheduling system 114 may generate a data structure for storing collaborator data for the team.

FIG. 3C depicts an example data structure 300C that represents collaborator data for a given team. As depicted, the data includes an employee ID field 310 that stores the employee identification of team members of a given team and another employee ID field 360 that stores employee identification of collaborates for a given team member. This information is then used to ensure collaboration between the team members and additional employees are also taken into consideration when designing the hybrid workplan schedule.

In some implementations, employees' preferred work locations for given workdays are known. For example, the data may be retrieved from organizational data 220 or provided by the requesting user who submitted the request for a hybrid workplan schedule. In another example, the preference data is provided by each team member. For example, a link to a survey may be sent to the team members. The poll may enable the team members to choose their desired location from the list for each workday.

When the location preference data is not known (e.g., the employee has not provided their preferred work location and/or the requesting user does not know the employee's preference), the preference detection engine 270 is utilized to infer each team member's preferred location. The team preference detection engine 270 utilizes the employee data 210, organizational data 220, team data 230 and/or collaboration data 240 to infer a team members' preferred work location for a given workday. Preference detection involves first detecting the user's location on a given workday for a specific time period (e.g., the employee's location on Mondays for the past 6 months). Once the location is detected, then the preference detection engine 270 examines the location from which the user worked on a majority of the given workday during the examined time period. If a pattern is easily detected (e.g., the employee worked a majority of Mondays for the past 6 months from home), then the detected majority is identified as the employee's preference. If a majority is not detected and/or when the employee's location is not clear from the employee data, a preference detection model 275 may be utilized to detect the employee's preference. This involves use of one or more ML models for predicting the user's preferred location based on past behavior and/or patterns in user behavior.

The preference detection model 275 may receive the employee data 210, organizational data 220 and/or collaboration data 240 as inputs and analyze the data to predict the employee's preferred location based on patterns in user behavior and/or other parameters. For example, the preference detection model 275 may examine employee data 210 and/or organizational data 220 to detect that a user often attends a meeting at a specific office building on Tuesday mornings. Based on this information, the preference detection model 275 may predict that the user's preferred work location is that office building on Tuesdays. In another example, the preference detection model 275 may detect that an office designated to an employee was used on a majority of Mondays for the past two months. This information may be inferred from smart office data such as light sensors, thermostat data, use of a desktop at the office and the like. Based on this information, the preference detection model 275 may infer that the employee has been working from that office on a majority of Mondays for the past two months. The preference detection model 275 may then use this information to determine that the employee prefers to work from that office on Mondays. Alternatively, the number of days the employee worked from the office and number of days the employee worked from home on the given workday is taken into account to generate a value for the likelihood that the employee will work from the office (or home) on that day in the future. In situations where an employee's location cannot be detected, location information for users that are closely associated with the employee may be used to infer the employee's location. For example, if it is known that a first employee often works in-person with a second employee, the second employee's location information may be used to infer the first employee's location.

In some implementations, the preference detection engine 270 calculates a value for the likelihood that an employee will come to the office on a specific workday (e.g., on Mondays). Denoting an employee i, the likelihood of the employee coming to the office for a day that is denoted as d, where d∈{Mon, Tue, Wed, Thur, Fri}, is represented by pᵢ^{d}∈[0,1]. For employee i that works from home (i.e., has a home office), pᵢ^{d}=0 for any day d. The value of pᵢ^{d} is calculated for all workdays for each employee in a team and may be used as an indication of employee preference when generating the workplan schedule. In some implementations, once the preferred location of the employees of interest have been determined, and a likelihood of the employees coming to the office on each workday is measured, the preference detection engine 270 generates a data structure for team member's likelihood of coming to the office on each workday.

FIG. 3D depicts an example data structure 300D that likelihood of employees coming to the office on each workday. As depicted, data structure 300D includes an employee ID field 310 that stores each employee's identification. Additionally, data structure 300D includes data fields 370, 375, 380, 385, and 390, for each day of the workweek. The data field 370 stores the value for the employees' likelihood of coming to the office on Mondays, while data field 375 stores the value for the likelihood of the employees' working from the office on Tuesdays, and so on. Thus, the data structure 300D depicts that the employees having the employee IDs BB98754 and DD32652 work from home on all workdays, while the employee having the employee ID AA32654 always works from the office on Wednesdays and Thursdays.

The data structures and/or additional data generated by the team generating engine 250, collaboration detection engine 260 and preference detection engine 270 are transmitted to the workplan generating engine 280, which analyzes the various data structures and/or data points to generate an optimized hybrid workplan schedule. This involves considering three parameters: preference alignment, co-location of team members, and co-location of collaborators of the team members. The workplan generating engine 280 utilizes an optimization approach that considers each of these parameters and attempts to optimize all of them.

In some implementations, the optimization approach involves first measuring an average likelihood of the members of a given team coming to the office and second measuring an average likelihood of collaborators of each member of the team combing to the office. This may be done by denoting τⱼ as the set of employees on a team denoted as j and defining Nᵢ as the set of collaborators of employee i who are on different teams from employee i. The average likelihood of employees of team j coming to the office is then denoted as αⱼ^{d} and can be measured using the following equation.

$${α}_{j}^{d} = \frac{{\sum }_{i ∈ {τ}_{j}} {p}_{i}^{d}}{\vert {τ}_{j} \vert} \qquad ( 1 )$$

Similarly, a metric βᵢ^{d} is used to denote the likelihood of an employee i's collaborators coming to the office on day d and is measured using the following equation.

$${β}_{i}^{d} = \frac{{\sum }_{k ∈ {N}_{i}} {p}_{k}^{d}}{\vert {N}_{i} \vert} \qquad ( 1 )$$

Once the likelihood of the team members and their collaborators coming to the office on a given day are measured, the workplan generating engine 280, measure a utility parameter for a given employee i on team j in terms of three components: preference alignment, co-location of the employee with their team members, and co-location with their collaborators on different teams. This is to ensure all three parameters are taken into account and contrasting utilities of the parameters are also considered when creating the final workplan. For example, if a workplan dictates that all employees can work remotely, employees with less tendency of coming in the office derive less utility from collaboration with their team members and other collaborators.

To take the utility of preference alignment into account, a parameter of 1-2pᵢ^{d} is used for quantifying preference alignment for the remote work option. This quality linearly scales from −1, when employee i always comes to the office on day d, and is maximized as +1, when the employee is always working remotely. The utility function of preference alignment for working fully from the office can operate similarly with a reverse orientation (i.e., 2pᵢ^{d}−1, which linearly scales from −1, when the employee always works remotely, to +1, when the employee always work from the office). A flexible option which allows the employees to choose their own preference can be offered. For the flexible option the utility of employee preferences is always maximized.

To take co-location of team members into account, a utility parameter may be used that has a value of 0 when the employees work remotely and a value of 1 when the employees come to the office. This mean that the employees do not derive any utility from co-location with their team members when they work remotely, and they fully derive utility from co-location when all of the employees come to the office. For the flexible option, pᵢ^{d} is used to denote an employee's tendency to come to the office and 1−pᵢ^{d} as their tendency to work remotely. If employee i comes to the office, they derive a utility of 2αⱼ^{d}−1, which ranges from −1 to +1, depending on the fraction of other teammates in the office (αⱼ^{d}). The reason the utility value can be −1 is it is possible for an employee to come to the office when no other team members or collaborators are there. That is a significant disutility for that employee. When the employee does not come to the office, when team members or collaborators are in the office, the employee will not gain any co-location benefit. That means the utility value is 0. If employee i does not come to the office, then they lose the opportunity of meeting other team members in person. This is denoted by (−αⱼ^{d}). Thus, for the flexible option, the utility of co-location of team members can be represented by pᵢ^{d}(2αⱼ^{d}−1)+(1−pᵢ^{d})(−αⱼ^{d}).

To consider co-location with collaborators, a utility parameter may be used that ranges from 0, when all the employees work remotely, to βᵢ^{d}, when all the employees come to the office. That is because the fraction of the collaborators who can likely be met in person is βᵢ^{d}. Thus, even if all of the team members come to the office, the maximum utility they receive from collaboration with other collaborators is βᵢ^{d}. For the flexible option, the utility of co-location with collaborators can be represented by pᵢ^{d}βᵢ^{d}. In contrast to measurement of the utility parameter for co-location of team members, co-location with collaborators only considered the benefits of meeting collaborators in person and not the disability of not meeting those at home. This is because collaboration with collaborators is not given as much value as collaboration with teammates. These parameters are illustrated in Table 1.

TABLE 1

| | Preference | Co-location of | Co-location with |
|---|---|---|---|
| Workplan | Alignment | Team Members | Collaborators |
| Remote | 1 − 2pᵢ^{d} | 0 | 0 |
| Flexible | 1 | pᵢ^{d} (2αⱼ^{d} − 1) + (1 − pᵢ^{d})(−αⱼ^{d}) | pᵢ^{d} βᵢ^{d} |
| Office | 2pᵢ^{d} − 1 | 1 | βᵢ^{d} |

After each team members utility for preference alignment, co-location of team members and co-location with collaborators is measured, the workplan generating engine 280 maximizes the aggregate of team members' utilities to generate a workplan that is likely to optimize all the various parameters for the various team members. This may be achieved by aggregating the utilities of team j and normalizing it with team size T for the three components and the three different options of working remotely, flexible and working from the office. Thus, the workplan generating engine 280 aggregates a utility U for a workplan w on a workday d. This can be denoted as Uⱼ^{d}(w, selected component). The aggregated utilities are illustrated in Table 2.

TABLE 2

| | Preference | Co-location of | Co-location with |
|---|---|---|---|
| Workplan | Alignment | Team Members | Collaborators |
| Remote | 1 − 2αⱼ^{d} | 0 | 0 |
| Flexible | 1 | 3(αⱼ^{d})² − 2αⱼ^{d} | $\frac{1}{\vert {τ}_{j} \vert} {\sum }_{i ∈ {τ}_{j}} {p}_{i}^{d} {β}_{i}^{d}$ |
| Office | 2αⱼ^{d} − 1 | 1 | $\frac{1}{\vert {τ}_{j} \vert} {\sum }_{i ∈ {τ}_{j}} {β}_{i}^{d}$ |

After the aggregated utilities have been measured, to balance the three parameters, weights are set for the components that reflect the relative importance of the parameters. The weights may be predetermined, for example, based on an organization's predetermined importance of each of the employee preference, co-location of team members, and co-location of collaborators. Alternatively, the weights are adjustable and can be provided as an input to the workplan generating engine 280, by for example the requesting user. For example, the manager that is requesting a workplan schedule can input values for importance of each of these parameters. The weight for employee preference can be denoted as δ_{P}, while the weight for co-location of team members is denoted by δ_{CT} and the weight for co-location of collaborators is denoted by dcc. The weights should satisfy δ_{P}+δ_{CT}+δ_{CC}=1. The workplan generating engine 280 then optimizes the variables to generate a workplan for a given workday d via the following optimization algorithm:

$$arg \begin{matrix}max \\ w ∈ \{ Remote , Flexable , Office \}\end{matrix} {δ}_{P} {U}_{j}^{d} ( w , preference alignment ) + {δ}_{CT} {U}_{j}^{d} ( w , team {members}^{′} co - location ) + {δ}_{CT} {U}_{j}^{d} ( w , {collaborators}^{′} co - location ) . \qquad ( 1 )$$

The objective of algorithm 1 is to maximize the utilities illustrated in Table 2. This enables the workplan generating engine 280 to generate an optimized team workplan on any workday. The workplans for each workday are then combined to generate a hybrid workplan schedule for a work week. The output is the generated workplan 290 which is transmitted by the hybrid workplan scheduling system 114 for display to the requesting user.

In this manner, the hybrid workplan scheduling system 114 enables efficient and effective creation of a hybrid workplan schedule that balances the needs of the employees and the advantages of in-person collaboration and generates an optimized workplan for an entire team. This is made even more efficient by being able to automatically predict employee's preferred work locations on workdays, automatically identify collaborators of employees and/or automatically generate teams for an organization. In this manner, the hybrid workplan scheduling system 114 increases efficiency and satisfaction and increases employees' opportunity frame for in-person collaboration.

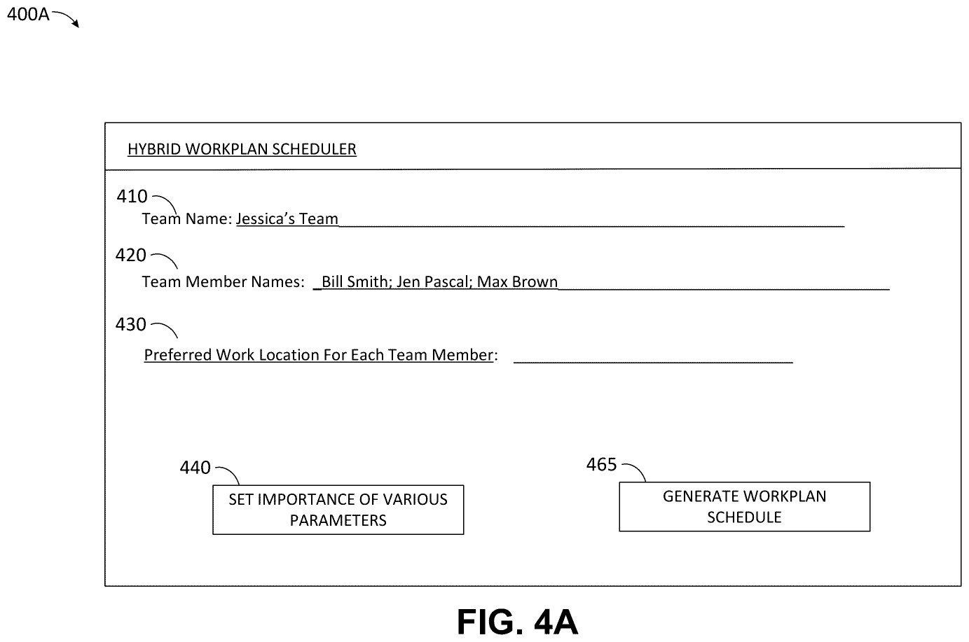

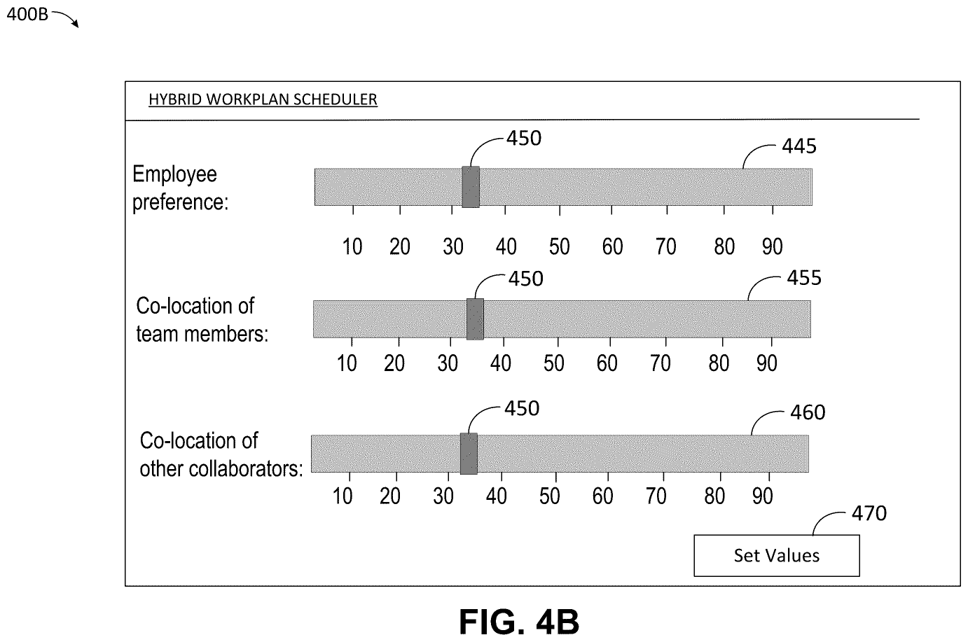

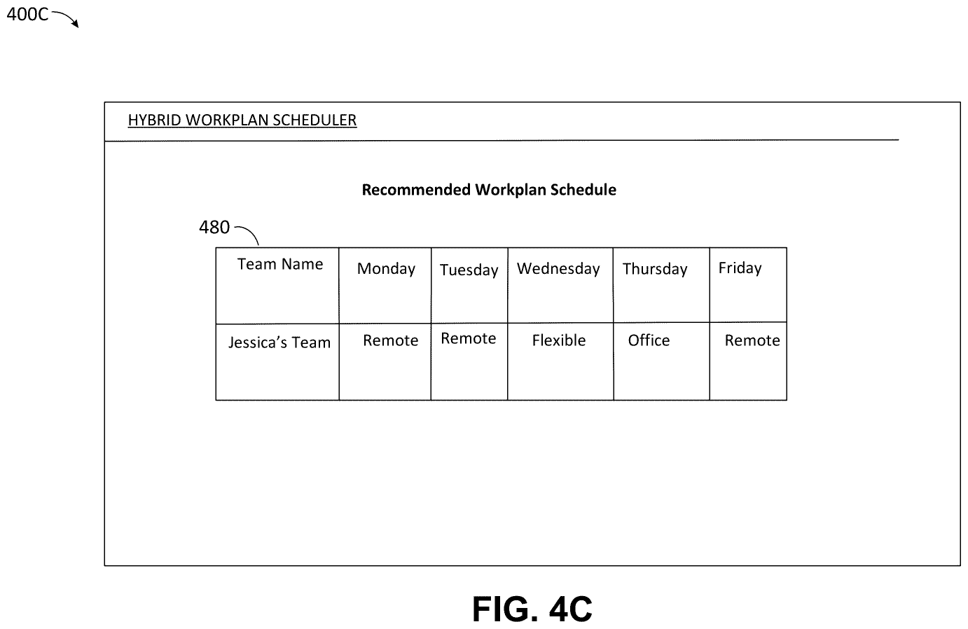

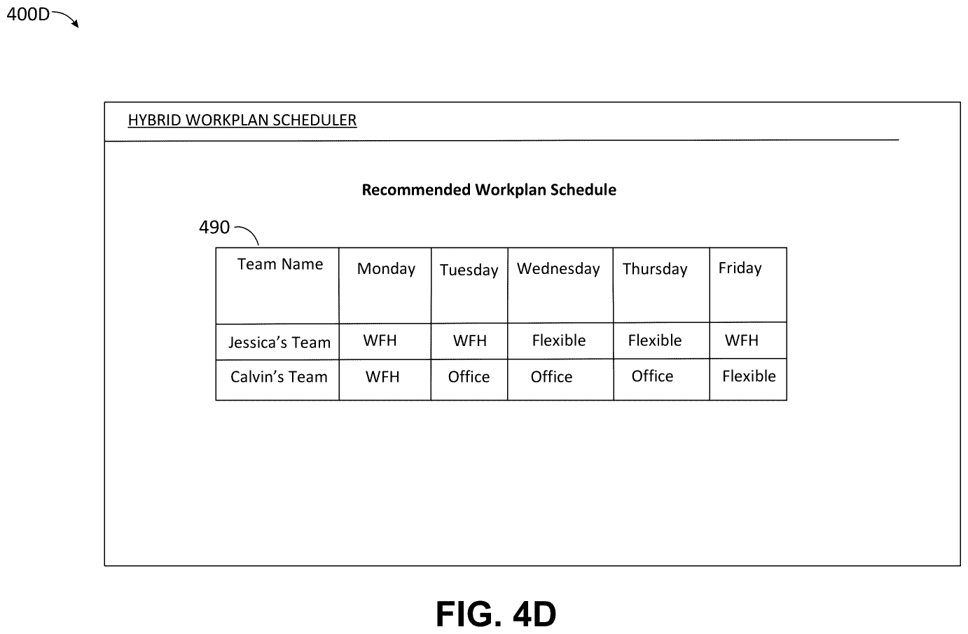

FIGS. 4A-4D depict example GUI screens of an application or service that automatically generates an optimized hybrid workplan schedule for a team. FIG. 4A depicts an example GUI screen 400A of a workplan scheduling application or management or calendar application that provides workplan scheduling functionalities. The GUI screen 400A includes UI element 410 for entering a name of the team, UI element 420 for entering names of the team members, and UI element 430 for entering the preferred work location of one or team members. In some implementations, instead of team member names, other identifying information for the team members are provided. In an example, to better identify the team members, email addresses may be requested. Moreover, to enter the preferred work location of each team member, an option may be provided to select each member and then enter their preferred work location. Alternatively, the team members and/or their preferred work locations may be left blank and/or the GUI screen 400A may not offer the option of entering these inputs, when the system automatically generates team and/or detects employee preferences.

Additionally, the GUI screen 400A includes a UI element 440 for enabling a user to set an importance level for one or more parameters in the final workplan schedule. The user can select the UI element 440 to enter those parameters. Once all of the desired and/or required input has been entered, the user can select the UI element 465 to request that a workplan schedule be generated. Upon selecting the UI element 440, a GUI screen such as the GUI screen 400B of FIG. 4B may be displayed. The GUI screen 400B includes a selectable percentage bar 445 for selecting a level of importance for employee preference, a selectable percentage bar 455 for selecting a level of importance for co-location of team members and a selectable percentage bar for selecting a level of importance for co-location of other collaborators.

The percentage bars 445, 455 and 460 include markers that display percentages selected for each parameter. By moving the slidable bar 450 on each of the percentage bars 445, 455 and 460 the user is able to select the level of importance the user desires to give each parameter. For example, to ensure a balanced distribution, the user may move the slidable bar 450 to select 33% of each of the employee preference, co-location of team members and co-location of other collaborators. Once the selections are made, a set values menu button 470 may be utilized to select the values and return back to the GUI screen 400A of FIG. 4A.

Once the selections are made and the user invokes the UI element 465 to generate a workplan schedule, the system automatically generates a workplan schedule. The generated workplan schedule is then displayed on a GUI screen such as the GUI screen 400C of FIG. 4C. As depicted, the screen displays a workplan schedule 480 which includes a suggested work location for each day of the work week for the selected team. When a request is made to generate workplan schedules for multiple teams, a GUI screen such as the GUI screen 400D of FIG. 4D is displayed. The GUI screen 400D displays a workplan schedule 490 that includes recommended work locations for two teams. As depicted, the recommendations vary significantly, based on the team members and/or importance of the various parameters given for the two teams.

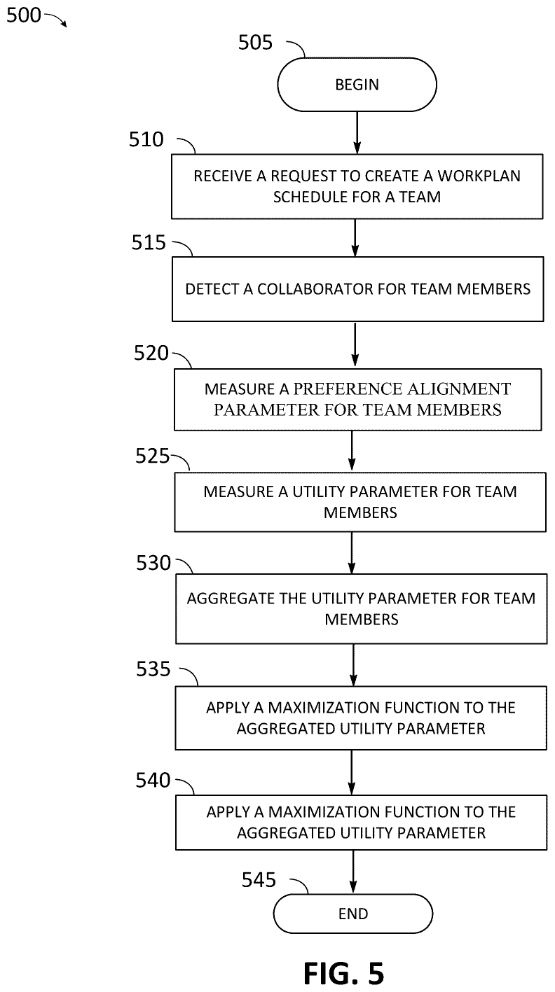

FIG. 5 is a flow diagram depicting an example method 500 for automatically generating a hybrid workplan schedule for a team of employees in an organization. The workplan schedule sets a work location for each day of the workday for the team members. The work locations may include office, home office or flexible option (e.g., the employee can choose their preferred work location). One or more steps of the method 500 may be performed by a system such as the hybrid workplan scheduling system 114 of FIGS. 1-2 or by an application such as applications 116/124 of FIG. 1.

The method 500 begins, at 505, and proceeds to receive a request to request to create a workplan schedule for the team, at 510. This may occur, for example, via a user interface screen of an application or webpage that provides a user interface element for transmitting a request to generate a workplan schedule for a team. A team is a group of two or more employees in the organization who are grouped together because of various reasons, such as sharing the same manager, working on the same project, working in the same filed, and the like. The team may be predetermined, identified by a user (e.g., a manager who submits the request) or may be inferred by the system, as discussed above. In some implementations, the user interface screen also the user to enter team information, such as a list of team members for a team, team member preferences for one or more members of the team, team collaborators for one or more members of the team and/or the level of importance of various factors such team member preferences, co-location of team members and co-location of team members with their collaborators, in the workplan schedules. In some implementations, the request is generated automatically by the application or a system, for example, when new employees are added to a team in the organization or when the organization adds a new team.

Once a request for creating a workplan schedule has been received, method 500 proceeds to detect one or more collaborators for one or more members of the team, at 515. A collaborator is an employee of the organization who is not a member of the team and with whom at least one of the team members collaborate on a regular basis. Detecting the collaborator may involve use of one or more ML models. In some implementations, to detect a collaborator for one or more of the team members, collaboration data is first retrieved. Collaboration data is data associated with communications or other relationships between each member of the team and other employees of the organization. In some implementations, in addition to collaboration data, employee data and/or team data is also retrieved.

In some implementations, a preference alignment parameter for each of the team members is measured for each workday, at 520. The preference alignment parameter is measured based on a measured value for the likelihood that a team member prefers to work from a specific location (e.g., home or office) on a specific workday (e.g., on Tuesdays). Method 500 then proceeds, at 525, to measure a utility parameter for the team members based on the preference alignment parameter, a team member co-location parameter for the team members being at a same location as their team members, and a co-location with collaborators parameter for each team member being at a same location as their collaborators on each specific workday.

The measured utility parameter for the team members is then aggregated, at 530, for all the team members to measure an aggregated utility parameter for the entire team for each given workday. A maximization function is then applied to the aggregated utility parameter, at 535, based on a relative weighing of the preference alignment parameter, the team member co-location parameter and the co-location with collaborators parameter to generate the workplan schedule based on the maximized aggregated utility parameter. The weights for the maximization function may be provided by the user, for example, via a user interface element that enables the user to select the level of importance of each of the parameters. In this manner, the maximization function takes the importance of each parameter into account in maximizing the utility function. After maximizing the utility function, method 500 generates a workplan schedule, at 540, by selecting a work location for each workday based on the output of the maximization function. The generated workplan schedule may then be provided to an application for display to a user.

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as client devices, native application providers, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764 such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
      retrieving employee data associated with a plurality of employees of an organization;
      retrieving team data for a team of employees of the organization, the team including two or more team members;
      retrieving collaboration data associated with collaboration between the plurality of employees;
      identifying, using a collaboration detection engine, based on the collaboration data, one or more collaborators for one or more team members, the one or more collaborators being employees of the organization who are not a team member of the team;
      measuring for each team member for each of one or more days of a week, using a preference detection engine, a value for a likelihood that the team member prefers to work from a specific location on each of the one or more days of the week;
      measuring a preference alignment parameter for the two or more team members based on the measured value for the likelihood that the team member prefers to work from the specific location on each of the one or more days of the week;
      measuring a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more their collaborators;
      aggregating the utility parameter for the two or more team members;
      applying a maximization function to the aggregated utility parameter based on a relative weighing of the preference alignment parameter, the team member co-location parameter and the co-location with collaborators parameter; and
      generating a workplan schedule for the team based on the maximized aggregated utility parameter.
Item 2. The data processing system of item 1, wherein the workplan schedule for the team identifies for the one or more days of the week a work location from which the team members should work.
Item 3. The data processing system of item 2, wherein the work location includes at least one of an office location, a home office or a flexible location.
Item 4. The data processing system of item 1, wherein the relative weighing of the preference alignment parameter, the team member co-location parameter and the co-location with collaborators parameter is based on a weight value set for each of the preference alignment parameter, the team member co-location parameter and the co-location with collaborators parameter.
Item 5. The data processing system of item 4, wherein the weight value for one or more of the preference alignment parameter, the team member co-location parameter and the co-location with collaborators parameter is set based on a user provided input.
Item 6. The data processing system of item 5, wherein the user provided input is provided via a user interface screen that includes one or more user interface elements for selecting the weight for the preference alignment parameter, the team member co-location parameter and the co-location with collaborators parameter.
Item 7. The data processing system of item 1, wherein the memory comprises executable instructions that, when executed by processor, further cause the data processing system to perform functions of automatically identifying the two or more team members for the team based on at least one of the employee data, collaboration data or organizational data associated with the organization.
Item 8. The data processing system of item 1, wherein the memory comprises executable instructions that, when executed by processor, further cause the data processing system to perform functions of receiving a request, via a user interface element to generate a hybrid workplan schedule for the team.
Item 9. A method for automatically generating a workplan schedule for a team of employees in an organization comprising:
   receiving, via a user interface screen of an application, a request to automatically create a workplan schedule for the team, the team including two or more team members who are employees of the organization and the workplan schedule identifying for one or more workdays a work location for the two or more team members;
   detecting, using a collaboration detection engine, a collaborator for one or more of the two or team members, the collaborator being an employee of the organization who is not a member of the team and with whom at least one of the two or more team members collaborate;
   measuring, using a workplan generating engine, a preference alignment parameter for the two or more team members for the one or more workdays;
   measuring, using the workplan generating engine, a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more of their collaborators;
   aggregating the utility parameter for the two or more team members;
   applying a maximization function to the aggregated utility parameter based on a relative weighing of the preference alignment parameter, the team member co-location parameter and the co-location with collaborators parameter; and
   generating the workplan schedule based on the maximized aggregated utility parameter.
Item 10. The method of item 9, wherein the workplan generating engine optimizes one or more of the preference alignment parameter, the team member co-location parameter, and the co-location with collaborators parameter.
Item 11. The method of any of items 9 or 10, wherein the preference alignment parameter is measured based on a likelihood that each of the two or more team members prefer to work from a specific location on a given workday.
Item 12. The method of item 11, wherein a machine-learning model is used to identify the specific location from which the two or more team members prefer to work on the given workday.
Item 13. The method of any of items 9-12, wherein a machine-learning model is applied to collaboration data of the organization to detect the collaborator for the one or more of the two or more team members.
Item 14. The method of any of items 9-13, further comprising automatically generating the team by identifying the two or more team members for the team.
Item 15. The method of any of items 9-14, wherein the generated workplan schedule is provided for display on a user interface screen of an application.
Item 16. The method of any of items 9-15, further comprising:
   displaying a selectable user interface element on a user interface screen for enabling a user to select a weight for one or more of the preference alignment parameter, a team member co-location parameter for the one or more of the two or more team members being at a same location as their team members, and a co-location with collaborators parameter;
   receiving via the selectable user interface element the weight; and
   utilizing the received weight to applying the maximization function to the aggregated utility parameter.
Item 17. A non-transitory computer readable medium on which are stored instructions that, when executed, cause a programmable device to perform functions of:
   identifying, using a collaboration detection engine, one or more collaborators for one or more team members of a team, the collaboration detection engine identifying the one or more collaborators based on collaboration data associated with collaboration between a plurality of employees of an organization, the one or more collaborators being employees of the organization who are not a team member of the team;
   measuring for each team member for each of one or more days of a week, using a preference detection engine, a value for a likelihood that the team member prefers to work from a specific location on each of the one or more days of the week;
   measuring a preference alignment parameter for the one or more team members based on the measured value for the likelihood that the team member prefers to work from the specific location on each of the one or more days of the week;
   measuring a utility parameter for one or more of the one or more team members, the utility parameter being measured based on the preference alignment parameter, a team member co-location parameter for the one or more of the one or more team members being at a same location as their team members, and a co-location with collaborators parameter for the one or more of the one or more team members being at a same location as the one or more of their collaborators;
   aggregating the utility parameter for the one or more team members;
   applying a maximization function to the aggregated utility parameter based on a relative weighing of the preference alignment parameter, the team member co-location parameter and the co-location with collaborators parameter; and
   generating a workplan schedule for the team based on the maximized aggregated utility parameter.
Item 18. The non-transitory computer readable medium of item 17, wherein a predetermined weight is used for each of the preference alignment parameter, the team member co-location parameter and the co-location with collaborators parameter.
Item 19. The non-transitory computer readable medium of any of items 17 or 18, wherein the maximization function maximizes the aggregated utility function for the team.
Item 20. The non-transitory computer readable medium of any of items 17-19, wherein the workplan schedule is an optimized workplan for the team.

In the foregoing detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
retrieving employee data associated with a plurality of employees of an organization;
retrieving team data for a team of employees of the organization, the team including two or more team members;
retrieving collaboration data associated with collaboration between the plurality of employees;
identifying, using a collaboration detection engine, based on the collaboration data, one or more collaborators for one or more team members, the one or more collaborators being employees of the organization who are not a team member of the team;
measuring for each team member for each of one or more days of a week, using a preference detection engine, a value for a likelihood that the team member prefers to work from a specific location on each of the one or more days of the week;
measuring a preference alignment parameter for the two or more team members based on the measured value for the likelihood that the team member prefers to work from the specific location on each of the one or more days of the week;
measuring a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more their collaborators;
aggregating the utility parameter for the two or more team members;
applying a maximization function to the aggregated utility parameter based on a relative weighing of the preference alignment parameter, the team member co-location parameter and the co-location with collaborators parameter; and
generating a workplan schedule for the team based on the maximized aggregated utility parameter.

2. The data processing system of claim 1, wherein the workplan schedule for the team identifies for the one or more days of the week a work location from which the team members should work.

3. The data processing system of claim 2, wherein the work location includes at least one of an office location, a home office or a flexible location.

4. The data processing system of claim 1, wherein the relative weighing of the preference alignment parameter, the team member co-location parameter and the co-location with collaborators parameter is based on a weight value set for each of the preference alignment parameter, the team member co-location parameter and the co-location with collaborators parameter.

5. The data processing system of claim 4, wherein the weight value for one or more of the preference alignment parameter, the team member co-location parameter and the co-location with collaborators parameter is set based on a user provided input.

6. The data processing system of claim 5, wherein the user provided input is provided via a user interface screen that includes one or more user interface elements for selecting the weight for the preference alignment parameter, the team member co-location parameter and the co-location with collaborators parameter.

7. The data processing system of claim 1, wherein the memory comprises executable instructions that, when executed by processor, further cause the data processing system to perform functions of automatically identifying the two or more team members for the team based on at least one of the employee data, collaboration data or organizational data associated with the organization.

8. The data processing system of claim 1, wherein the memory comprises executable instructions that, when executed by processor, further cause the data processing system to perform functions of receiving a request, via a user interface element to generate a hybrid workplan schedule for the team.

9. A method for automatically generating a workplan schedule for a team of employees in an organization comprising:
receiving, via a user interface screen of an application, a request to automatically create a workplan schedule for the team, the team including two or more team members who are employees of the organization and the workplan schedule identifying for one or more workdays a work location for the two or more team members;
detecting, using a collaboration detection engine, a collaborator for one or more of the two or team members, the collaborator being an employee of the organization who is not a member of the team and with whom at least one of the two or more team members collaborate;
measuring, using a workplan generating engine, a preference alignment parameter for the two or more team members for the one or more workdays;
measuring, using the workplan generating engine, a utility parameter for one or more of the two or more team members, the utility parameter being measured based on the preference alignment parameter, a team member co-location parameter for the one or more of the two or more team members being at a same location as their team members, and a co-location with collaborators parameter for the one or more of the two or more team members being at a same location as the one or more of their collaborators;
aggregating the utility parameter for the two or more team members;
applying a maximization function to the aggregated utility parameter based on a relative weighing of the preference alignment parameter, the team member co-location parameter and the co-location with collaborators parameter; and
generating the workplan schedule based on the maximized aggregated utility parameter.

10. The method of claim 9, wherein the workplan generating engine optimizes one or more of the preference alignment parameter, the team member co-location parameter, and the co-location with collaborators parameter.

11. The method of claim 9, wherein the preference alignment parameter is measured based on a likelihood that each of the two or more team members prefer to work from a specific location on a given workday.

12. The method of claim 11, wherein a machine-learning model is used to identify the specific location from which the two or more team members prefer to work on the given workday.

13. The method of claim 9, wherein a machine-learning model is applied to collaboration data of the organization to detect the collaborator for the one or more of the two or more team members.

14. The method of claim 9, further comprising automatically generating the team by identifying the two or more team members for the team.

15. The method of claim 9, wherein the generated workplan schedule is provided for display on a user interface screen of an application.

16. The method of claim 9, further comprising:
displaying a selectable user interface element on a user interface screen for enabling a user to select a weight for one or more of the preference alignment parameter, a team member co-location parameter for the one or more of the two or more team members being at a same location as their team members, and a co-location with collaborators parameter;
receiving via the selectable user interface element the weight; and
utilizing the received weight to applying the maximization function to the aggregated utility parameter.

17. A non-transitory computer readable medium on which are stored instructions that, when executed, cause a programmable device to perform functions of:
identifying, using a collaboration detection engine, one or more collaborators for one or more team members of a team, the collaboration detection engine identifying the one or more collaborators based on collaboration data associated with collaboration between a plurality of employees of an organization, the one or more collaborators being employees of the organization who are not a team member of the team;
measuring for each team member for each of one or more days of a week, using a preference detection engine, a value for a likelihood that the team member prefers to work from a specific location on each of the one or more days of the week;
measuring a preference alignment parameter for the one or more team members based on the measured value for the likelihood that the team member prefers to work from the specific location on each of the one or more days of the week;
measuring a utility parameter for one or more of the one or more team members, the utility parameter being measured based on the preference alignment parameter, a team member co-location parameter for the one or more of the one or more team members being at a same location as their team members, and a co-location with collaborators parameter for the one or more of the one or more team members being at a same location as the one or more of their collaborators;
aggregating the utility parameter for the one or more team members;
applying a maximization function to the aggregated utility parameter based on a relative weighing of the preference alignment parameter, the team member co-location parameter and the co-location with collaborators parameter; and
generating a workplan schedule for the team based on the maximized aggregated utility parameter.

18. The non-transitory computer readable medium of claim 17, wherein a predetermined weight is used for each of the preference alignment parameter, the team member co-location parameter and the co-location with collaborators parameter.

19. The non-transitory computer readable medium of claim 17, wherein the maximization function maximizes the aggregated utility function for the team.

20. The non-transitory computer readable medium of claim 17, wherein the workplan schedule is an optimized workplan for the team.
